(19) United States
(12) Patent Application Publication
(10) Pub. No.: US 2025/0345847 A1
(43) Pub. Date: Nov. 13, 2025

(54) REFRACTORY PLATE, METHOD FOR THE PRODUCTION OF THE REFRACTORY PLATE, USE OF THE REFRACTORY PLATE, SLIDE GATE VALVE FOR CONTROLLING A FLOW OF MOLTEN METAL AND VESSEL FOR CONTAINING MOLTEN METAL

(71) Applicant: REFRACTORY INTELLECTUAL PROPERTY GMBH & CO. KG, Wien (AT)

(72) Inventors: Sabine GSCHIEL, Leoben (AT); Stephan NESTL-RÖSCHEL, Krieglach (AT); Luis SAMPAYO RODRIGUEZ, Wien (AT); Tamara TISCHLER, Marktredwitz (DE)

(21) Appl. No.: 18/860,377

(22) PCT Filed: Apr. 24, 2023
(86) PCT No.: PCT/EP2023/060691

§ 371 Date: Oct. 25, 2024

(30) Foreign Application Priority Data
Apr. 27, 2022 (EP) 22170298.8

(51) Int. Cl. B22D 41/32

(52) U.S. Cl. CPC B22D 41/32

(57) ABSTRACT

The invention relates to a refractory plate for use in a slide gate valve for controlling a flow of molten metal, a method for the production of the refractory plate, a use of the refractory plate, a slide gate valve for controlling a flow of molten metal and vessel for containing molten metal.

The invention relates to a refractory plate for use in a slide gate valve for controlling a flow of molten metal, a method for the production of the refractory plate, a use of the refractory plate, a slide gate valve for controlling a flow of molten metal and vessel for containing molten metal.

Refractory plates in a slide gate valve serve to control a flow rate of molten (i.e., liquid) metal, especially steel, from a melting vessel for receiving liquid or molten metal, respectively. Such a vessel may in particular be a ladle or tundish in a continuous casting plant for casting steel. In order to pour a metal melt in such a vessel into an aggregate downstream of the vessel in terms of production, such vessels have an opening which is arranged in particular at the bottom of such vessels.

Refractory plates in a slide gate valve are used to control the flow of molten metal through such an opening. Such plates have a channel or passage opening through which liquid metal can flow.

A slide gate valve is located in the area of the opening of the melting vessel. Such a slide gate valve comprises several refractory plates to control the flow of molten steel from the opening. To this extent, such a slide gate valve regularly comprises one or two fixed refractory plates, each of which has a channel which is aligned with the opening of the melting vessel. Another refractory plate, the so-called “slide gate plate”, lies flat against the fixed plates and is arranged so as to be slidable relative to these fixed plates. The slide gate plate can be slid into a first position in which the channel of the slide gate plate is aligned with the channel openings of the fixed plates so that the molten metal can flow out of the melting vessel through the opening of the melting vessel and the aligned channel openings of the plates. Furthermore, the slide gate plate can be moved to a second position in which the channel openings of the fixed plates are closed by the slide gate plate. In addition, the slide gate plate can be used for throttling the steel flow by moving it to positions between first and second position. A hydraulic or electric drive can be provided to move the slide gate plate.

Plates in a slide gate valve consist of refractory ceramic materials.

During the passage of liquid metal through the channel of the plate, it is exposed to extreme temperature changes, extreme temperatures and extreme mechanical or corrosive attack. The extreme temperature changes occur not only during the opening and closing of the gate valve but also during the passage of the molten metal through the channel due to temperature gradients within the plate.

In order to withstand these extreme loads, the refractory ceramic material of the plate must not only have a high refractoriness but also a high thermal shock resistance and a high corrosion resistance.

Despite the high thermal shock resistance and high corrosion resistance that prior art slide gate plates exhibit, the extreme temperature changes to which slide gate plates are subjected during their use lead to cracks in the plate. These cracks extend, starting from the channel, through the entire plate to its outer edge, where the plate is usually enclosed by a metal frame. Air can be drawn into the channel via these cracks due to the negative pressure that originates from adjusting the channel opening with the slide plate position to throttle the flow of steel during casting. This increases crack widening and crack propagation, which in turn increases the air intake. This effect is also known as “ratholing”, which in turn leads to a significantly reduced performance of the slide plate and increased operating risks (such as break-outs, production losses, etc.).

There has been no lack of attempts to counteract the effect of ratholing, for example by selecting special refractory materials for the refractory plate in a slide gate. In this respect, for example, carbon-bonded refractory materials are known to have excellent refractory properties, including in particular good refractoriness (high-temperature resistance), good thermal shock resistance and high corrosion resistance. However, carbon-bonded refractory materials are susceptible to oxidizing atmospheres, which the plate in a slide gate is sometimes exposed to during its service.

It is an object of the invention to provide a refractory plate for a slide gate valve which has good refractory properties and which at the same time offers a high resistance to the effect of ratholing. In particular, the plate shall have good refractory properties, such as high refractoriness, good thermal shock resistance and high corrosion resistance.

Furthermore, it is an object of the invention to provide a method for manufacturing such a plate.

Furthermore, the invention is directed to providing a vessel for holding molten metal comprising such a refractory plate.

In order to solve the problem, according to the invention, there is provided a refractory plate for use in a slide gate valve for controlling a flow of molten metal, comprising the following features:
a channel passing through said plate through which molten metal can flow;
a first portion made of a first refractory material; wherein
said channel is at least partially passing through said first portion; and
a second portion made of a second refractory material; wherein
said channel is spaced from said second portion; and wherein
said first refractory material is bonded by a carbon bond or a coking binder; and wherein
said second refractory material is not bonded by a carbon bond or a coking binder.

Surprisingly, it has been found in accordance with the invention that a plate formed as above can solve the problems underlying the invention. In particular, such a refractory plate can exhibit the aforementioned good refractory properties and at the same time form a high resistance to ratholing.

The invention is based on the finding that it is not easily possible to provide a refractory plate that has both good refractory properties and a high resistance to ratholing when it is made of only one refractory material. Rather, it is necessary to form the refractory plate from different refractory materials, each having different properties and synergistically complementing each other in terms of their effect.

The invention is further based on the finding that only refractory materials that are carbon bonded or have a coking binder, have the desired high refractory properties of good refractoriness (high temperature resistance), good thermal shock resistance and high corrosion resistance.

A “coking binder” shall mean a binder capable of undergoing a coking reaction when exposed to high temperatures. The coking reaction leads to a carbon bond. Further, as well known from the art, the high temperatures necessary for such coking reaction are usually reached under operating conditions of such slide gate plates. The necessary temperatures for such coking reactions start at about 600° C. Examples of coking binders include coal tar pitch, phenol-formaldehyde resins (Novolaks, Resols) and petroleum pitch.

The invention is further based on the finding that a refractory plate in a slide gate valve is exposed to an oxidizing atmosphere during its use substantially only in its outer region, i.e., the region spaced from the channel, while the region immediately surrounding the channel is hardly exposed to such an oxidizing atmosphere.

Against the background of these findings, the inventive idea arose to provide a refractory plate comprising two different refractory materials, namely a first refractory material which is carbon-bonded or has a coking binder, which encompasses the channel, and a second refractory material which is spaced from the channel and encompasses the first refractory material and which is not bonded by a carbon bond and not having a coking binder.

In accordance with the invention, it has surprisingly been found that such a refractory slide plate also provides a high resistance to the effect of ratholing. This is because, surprisingly, it has been found that cracks which form in the first refractory material in the region of the channel or passage opening, respectively, run essentially only through the first refractory material and fizzle out or die at the outer edge of the first refractory material or the interface or transition region from the first refractory material to the second refractory material. Although cracks also form in the second refractory material, they are in no relationship to the cracks of the first refractory material. In turn, cracks are not propagating from first to second refractory material through the interface between the two materials. In this way, the effect of ratholing can be largely or even completely suppressed.

In principle, the first refractory material can be made of any refractory material known from the art to be used for a refractory plate in a slide gate valve, and which is bonded by a carbon bond or has a coking binder. Preferably, the first refractory material may be based on at least one of the following refractory materials: Alumina (i.e., refractory materials based on Al₂O₃), magnesia (i.e., refractory materials based on MgO), spinel (i.e., refractory materials based on MgAl₂O₄) and bauxite (i.e., a refractory material based on Al₂O₃ with minor amounts of Fe₂O₃, SiO₂ and TiO₂). These materials may be supplemented, for example, by refractory materials based on zirconia (i.e., refractory materials based on ZrO₂) or zirconia mullite (i.e., refractory materials based on ZrO₂+3Al₂O₃·2SiO₂), zirconia corundum, zirconia spinel or micro silica. The refractory materials may comprise scrap or secondary (i.e., used and recycled) raw materials. Furthermore, the materials may comprise antioxidants known from the prior art, in particular metals or carbides. As known from the art, antioxidants are used to prevent decarbonization and to foster carbide formation in order to increase the strength of the refractory material. Preferably, the antioxidants are present as a powder. Preferably, the antioxidants are selected from the following group: aluminum (Al), silicon (Si), boron carbide (B₄C), silicon carbide (SiC), and aluminum silicon (AlSi), aluminum magnesium (AlMg), and aluminum magnesium silicon (AlMgSi) alloys. The first refractory may further comprise carbon-containing materials, such as graphite, carbon black and petrol coke in order to decrease porosity and/or to flexibilize the matrix. In the case of a carbon bond, the aforementioned materials are bonded to each other via a carbon bond, as known from the prior art. Insofar as the first refractory material comprises a coking binder, the materials of the first refractory material, in particular thus for example the aforementioned materials, are bonded via a coking binder. The coking binder may be one of the coking binders known from the prior art, which are coked by means of tempering and/or firing under reducing conditions and thereby form a binding carbon skeleton. In particular, the coking binder may be at least one of the following: coal tar pitches and resins. Resins may be at least one of the following: Novolaks and Resols. Preferably, the coking binder may be at least one resins, particularly preferably at least one of the aforementioned resins. According to a preferred embodiment, the first refractory material is comprised of 2 to 20% by mass of carbon and of 80 to 98% by mass of at least one oxide selected from the group consisting of: Al₂O₃, SiO₂, ZrO₂ and MgO.

More preferably, the first refractory material is comprised of 3 to 15% by mass carbon, of 85 to 97% by mass of at least one oxide selected from the group consisting of: Al₂O₃, SiO₂, ZrO₂ and MgO.

Even more preferably, the first refractory material is comprised of 3 to 11% by mass of carbon, of 89 to 97% by mass of at least one oxide selected from the group consisting of: Al₂O₃, SiO₂, ZrO₂ and MgO.

Even more preferable, the first refractory material is comprised of 6 to 9% by mass carbon, of 91 to 94% by mass of at least one oxide selected from the group consisting of: Al₂O₃, SiO₂, ZrO₂ and MgO.

The above mass fractions of the components of the first refractory material are based on the total mass of the first refractory material.

The second refractory material is not bonded by a carbon bond or a coking binder. Rather, the second refractory material preferably has a carbon content of less than 2% by mass, particularly preferable of less than 1% by mass.

Generally, the second refractory material can be made of any refractory material known from the art to be used for a refractory plate in a slide gate valve, and which is not bonded by a carbon bond and does not have a coking binder.

In principle, the second refractory material can be made of any refractory material known from the art, and which is not bonded by a carbon bond and has no coking binder.

Preferably, the second refractory material may be based on at least one of the following refractory materials: Alumina (i.e., refractory materials based on Al₂O₃), magnesia (i.e., refractory materials based on MgO), spinel (i.e., refractory materials based on MgAl₂O₄), bauxite (i.e., a refractory material based on Al₂O₃ with minor amounts of Fe₂O₃, SiO₂ and TiO₂), mullite and fireclay. The refractory materials may comprise scrap or secondary (i.e., used and recycled) raw materials. These materials may be supplemented, for example, by different additives, for example, microsilica, andalusite, alumina cement (i.e., cements based on Al₂O₃ and CaO) and dispersing agents.

Preferably, the second refractory material is based on alumina, i.e., a refractory material based on Al₂O₃. “Based on” means that, preferably, Al₂O₃ is the main oxide, present in a higher mass fraction than any other oxide.

Preferably, the second refractory material is comprised of 35 to 99% by mass Al₂O₃, of below 2% by mass carbon and of 1 to 65% by mass at least one of the following: SiO₂, CaO and Fe₂O₃.

More preferably, the second refractory material is comprised of 50 to 99% by mass Al₂O₃, of below 2% by mass carbon and of 1 to 50% by mass at least one of the following: SiO₂, CaO and Fe₂O₃.

Even more preferably, the second refractory material is comprised of 65 to 99% by mass Al₂O₃, of below 2% by mass carbon and of 1 to 35% by mass at least one of the following: SiO₂, CaO and Fe₂O₃.

Even more preferably, the second refractory material is comprised of 75 to 99% by mass Al₂O₃, of below 2% by mass carbon and of 1 to 25% by mass at least one of the following: SiO₂, CaO and Fe₂O₃.

Surprisingly, it has been found according to the invention that the occurrence of cracks in the second portion can additionally be suppressed particularly effectively if the second refractory material is based on the oxide Al₂O₃ and in addition has specific proportions of further oxides, in particular specific proportions of the oxides SiO₂, CaO and Fe₂O₃. In particular, the proportions of Fe₂O₃, especially also in combination with the proportions of SiO₂, have proven to be particularly relevant for additionally suppressing the occurrence of cracks in the second portion particularly effectively. The inventors assume that the second portion, in particular as far as it abuts against the first portion at an interface, forms mineralogical phases in the presence of these oxides in certain proportions, which impart a certain ductility to the second portion, due to which the occurrence of cracks in the second portion is suppressed.

Insofar, it may preferably be provided that the second refractory material is based on alumina and comprises 0.05 to 5% by mass Fe₂O₃, particularly preferably 0.05 to 2.0% by mass Fe₂O₃.

Further, it may preferably be provided that the second refractory material is based on alumina and comprises 0.1 to 64.95% by mass, more preferably 0.1 to 49.95% by mass, more preferably 0.1 to 34.95% by mass and particularly preferably 0.1 to 24.95% by mass SiO₂.

Preferably, the second refractory material is comprised of 35 to 99% by mass Al₂O₃, of below 2% by mass carbon and of 1 to 65% by mass at least one of the following: SiO₂, CaO and Fe₂O₃; and wherein it is comprised of 0.05 to 5% by mass Fe₂O₃ and 0.1 to 64.95% by mass SiO₂, more preferably of 0.05 to 2.0% by mass Fe₂O₃ and 0.1 to 64.95% by mass SiO₂.

More preferably, the second refractory material is comprised of 50 to 99% by mass Al₂O₃, of below 2% by mass carbon and of 1 to 50% by mass at least one of the following: SiO₂, CaO and Fe₂O₃; and wherein it is comprised of 0.05 to 5% by mass Fe₂O₃ and 0.1 to 49.95% by mass SiO₂, more preferably of 0.05 to 2.0% by mass Fe₂O₃ and 0.1 to 49.95% by mass SiO₂.

Even more preferably, the second refractory material is comprised of 65 to 99% by mass Al₂O₃, of below 2% by mass carbon and of 1 to 35% by mass at least one of the following: SiO₂, CaO and Fe₂O₃; and wherein it is comprised of 0.05 to 5% by mass Fe₂O₃ and 0.1 to 34.95% by mass SiO₂, more preferably of 0.05 to 2.0% by mass Fe₂O₃ and 0.1 to 34.95% by mass SiO₂.

Even more preferably, the second refractory material is comprised of 65 to 99% by mass Al₂O₃, of below 2% by mass carbon and of 1 to 25% by mass at least one of the following: SiO₂, CaO and Fe₂O₃; and wherein it is comprised of 0.05 to 5% by mass Fe₂O₃ and 0.1 to 24.95% by mass SiO₂, more preferably of 0.05 to 2.0% by mass Fe₂O₃ and 0.1 to 24.95% by mass SiO₂.

The above proportions of carbon and oxides in the first and second refractory materials are determined by a combination of the standards ISO 12677 and ISO 21068-2. For this purpose, the proportion of oxides was determined to 100% by mass according to ISO 12677. Secondly, the proportion of carbon was determined according to ISO 21068-2. Then, the determined 100% by mass of oxides and the determined % by mass of carbon were added. The resulting total mass (100% by mass oxides plus % by mass carbon) was then normalized to 100% by mass.

The first portion of the refractory plate according to the invention is made of the first refractory material.

Preferably, the first portion is made by pressing. Particularly preferably, the first portion is made by uniaxial pressing or isostatic pressing.

Preferably, the first portion is one-piece.

By providing the first portion as one-piece, this is particularly easy to manufacture and to handle for the manufacture of the refractory plate according to the invention.

The second portion of the refractory plate according to the invention is made of the second refractory material.

Preferably, the second portion is monolithic.

Particularly preferably, the second portion is made by casting.

In that the second portion is monolithic or is produced by casting, the second portion has the particular advantage that it is particularly easy to produce and has a particularly homogeneous structure. In particular, this also has the advantage of a very uniform force absorption, whereby stresses can be distributed and the crack propagation from first to second portion can be effectively prevented.

Preferably, the first portion and said second portion abut at an interface. To this extent, preferably, the first portion lies directly against the second portion. This has the particular advantage that forces emanating from the first portion can be absorbed by the second portion and dissipated to the outside. This can further prevent the formation of cracks.

According to the invention, it was found that ratholing can be prevented particularly effectively if the second portion completely surrounds or encompasses, respectively, the first portion. Preferably, the second portion completely surrounds the first portion in the plane of the refractory plate, i.e., in a plane normal to the longitudinal axis of the channel. It was found that ratholing can be reduced particularly effectively if the second portion completely surrounds the first portion with a thickness of at least 5 mm. According to a preferred embodiment, it is therefore provided that the second portion completely surrounds the first portion in a thickness of at least 5 mm, more preferably a thickness of at least 10 mm. Furthermore, it has been found according to the invention that ratholing can be counteracted particularly effectively if the second portion occupies a minimum volume, in particular a volume of at least 10%, relative to the total volume of the first and second portion. According to a preferred embodiment, it is therefore provided that the second portion has a volume in the range of 10 to 90% by volume and the first portion has a volume in the range of 90 to 10% by volume, even more preferably that the second portion has a volume in the range of 30 to 70% by volume and the first portion has a volume in the range of 70 to 30% by volume, each relative to the total volume of the first and second portion.

Preferably, the first portion and the second portion are arranged in a frame.

Corresponding frames for holding a refractory material of a slide plate are known in the art. The frame of the refractory plate according to the invention can be designed according to frames known from the prior art. Preferably, the frame is made of metal.

As known from the prior art, the frame may preferably comprise a bottom part and a rim part, the rim part projecting, preferably perpendicularly, from the bottom part at the edge thereof. Alternatively, the frame only comprises a rim part without a bottom part; in this case, the rim part forms a bandage. To this extent, the rim part forms the radial outer circumference or periphery, respectively, of the frame.

Preferably, the first portion is arranged with a distance from a radial outer circumference of the frame. Accordingly, if the frame comprises a rim part, as set forth above, the first portion is arranged with a distance from a rim of the frame. Preferably, this distance is at least 5 mm and particularly preferably at least 10 mm.

According to the invention, it has been found that oxidation of the first portion as well as the occurrence of ratholing can be counteracted particularly effectively if the first portion is arranged with a distance from the radial outer circumference of the frame.

According to a preferred embodiment, the second portion bridges the distance between the first portion and the radial outer circumference or rim of the frame.

According to the invention, it was found that ratholing can be counteracted particularly effectively when said second portion bridges said distance or gap between the first portion and the radial outer circumference of the frame.

The channel runs at least partially through the first portion. According to a particularly preferred embodiment, the channel is fully passing through the first portion. In other words, the channel is fully enclosed by the first portion, such that molten metal flowing through the channel does not contact the second portion and preferably only contacts the first portion and thus the first refractory material.

It is also an object of the invention to provide a method for the production of the refractory plate according to the invention, the method comprising the following steps:
providing the first portion;
providing a batch from which the second portion is castable;
casting the batch to form the second portion;
embedding the first portion in the second portion.

As previously disclosed, the first portion is made from the first refractory material, preferably by pressing.

Further, a batch is provided from which the second portion can be made. Accordingly, the batch can be made according to the second refractory material described before. According to the invention, the batch is provided as a castable, i.e., a refractory castable compound. This has the particular advantage that the slide gate plate according to the invention is particularly easy to manufacture.

In this respect, for the production of the slide gate plate according to the invention, the batch can be cast to form the second portion, so that, after casting, it forms the second portion, whereby the first portion can be embedded in the casting compound or the second portion formed therefrom.

According to a particularly preferred embodiment, it is provided that first the first portion is arranged and then the batch is cast around the first portion in such a way that the batch forms the second portion after casting and the first portion is arranged in the second portion.

According to a further embodiment of this method, it is particularly preferred to further provide a frame formed as above and to cast the batch into the frame.

According to a particularly preferred further embodiment of this inventive idea, it is provided that first the first portion is arranged in the frame and then the batch is cast around the first portion in the frame so that the batch forms the second portion and the first portion is embedded in the second portion. For casting, the first portion and the frame may be fixed relative to each other by means of a casting mold.

A further object of the invention is the use a refractory plate, as disclosed herein, in a slide gate valve for controlling a flow of molten metal.

A further object of the invention is a slide gate valve for controlling a flow of molten metal, comprising the refractory plate as disclosed herein.

The slide gate valve for controlling a flow of molten metal may comprise one or several of the refractory plates as disclosed herein.

A further object of the invention is to provide a vessel for containing molten metal comprising the following features:
an opening for discharging a flow of molten metal from said vessel; and
a slide gate valve as disclosed herein; wherein
the flow of molten metal through the opening is controllable by the slide gate valve.

Preferably, the vessel is a ladle or a tundish of a continuous casting machine for the continuous casting of molten metal, especially of molten steel. Alternatively, the vessel is a ladle of an ingot casting arrangement for the casting of molten metal, especially of molten steel.

Further features of the invention are apparent from the claims, the figures and the accompanying description of the figures.

All features of the invention may, individually or in combination, be combined with each other in any manner.

Examples of embodiments of the invention are also explained in more detail below with reference to the figures. In the Figures,

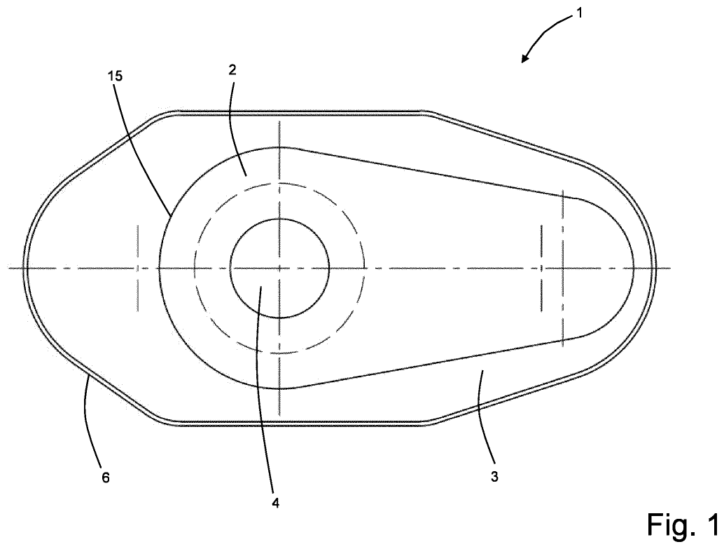

FIG. 1 shows a top view of an embodiment of a refractory plate according to the invention;

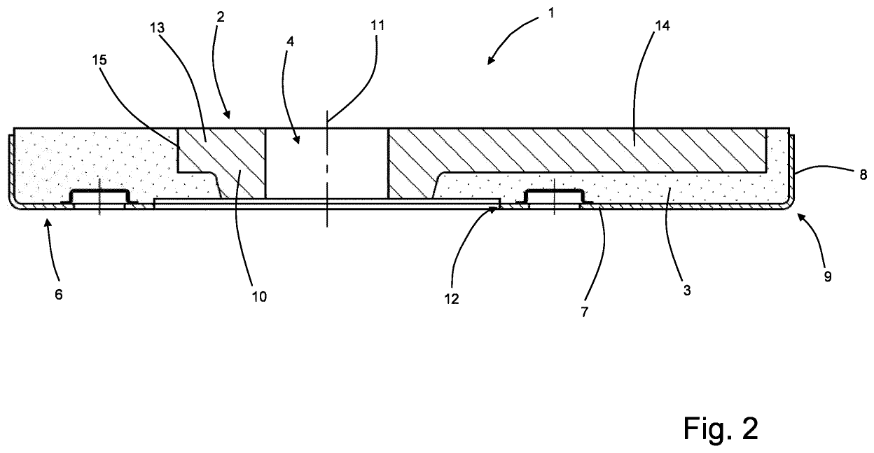

FIG. 2 shows a sectional view of a longitudinal cross-section through the plate according to FIG. 1;

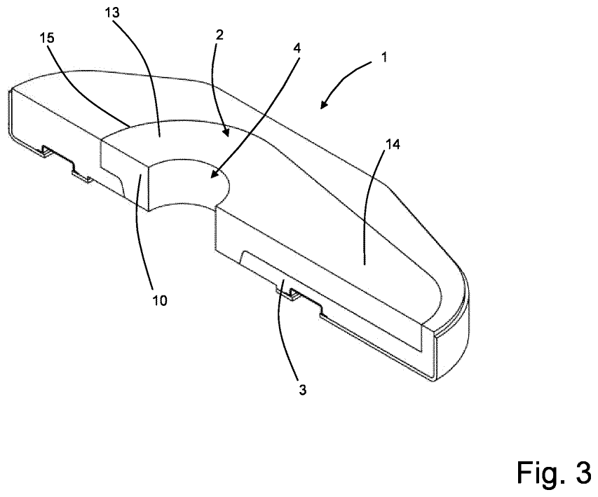

FIG. 3 shows a perspective view of a longitudinal cross-section of the plate according to FIG. 1;

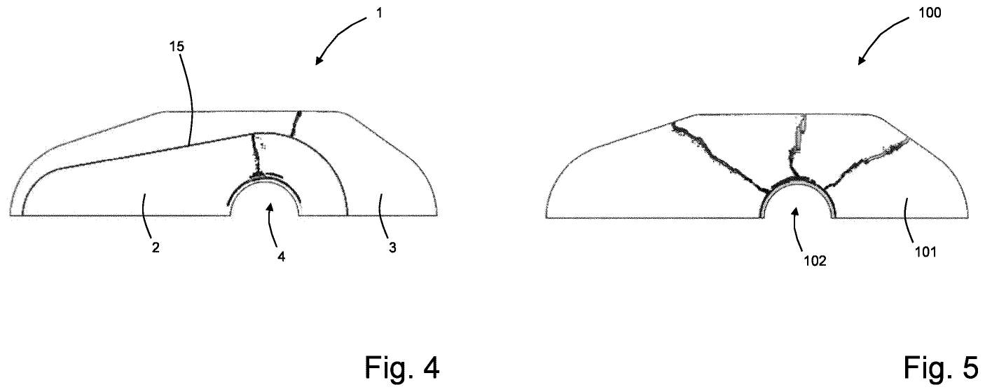

FIG. 4 shows the result of a simulation test on the occurrence of cracks due to stresses in a plate according to FIG. 1; and

FIG. 5 shows the result of simulation tests on the occurrence of cracks in a slide plate according to the state of the art.

FIG. 1 shows a top view of an embodiment of a refractory plate according to the invention. In its entirety, the refractory plate in FIG. 1 is denoted by the reference sign 1. The plate 1 comprises a first portion 2 made of a first refractory material and a second portion 3 made of a second refractory material. A channel 4 extends through the first portion 2 and is completely enclosed by the first portion 2. The plate 1 further comprises a metal frame 6 in which the first portion 2 and second portion 3 are fully incorporated. The first portion 2 and second portion 3 are in direct contact with each other and, hence, abut at an interface 15.

The metal frame 6 comprises a bottom portion 7 and a radial outer rim portion 8 extending perpendicularly away from the edge 9 of the bottom portion 7. The bottom portion 7 has an opening 12. The frame 6 thus has a substantially bowl-shaped configuration with an opening 12 in its bottom 7. The first portion 2 has a central section 10 which is mainly arranged above the opening 12 of the bottom portion 7. The channel 4 extends along a longitudinal axis 11, and leads completely through this central section 10 and enters into opening 12, so that the channel 4 forms a free through-opening through the plate 1. At its section distal from the bottom portion 7, the central section 10 has a circumferential collar 13, said collar 13 having an extended section 14 extending towards one side of the rim portion 8. The rim portion 8 of the frame 6 forms a radial outer circumference of the frame 6, to which the first portion 2 is always arranged with a distance.

The second portion 3 occupies the entire space between the first portion 2 and the metal frame 6.

In a plane normal to the longitudinal axis 11, the first portion 2 is thereby completely enclosed by the second portion 3, at any area with a minimum thickness of at least 10 mm.

In relation to the total volume of the first portion 2 and second portion 3, the first portion 2 occupies a volume of about 35% by volume and the second portion 3 a volume of about 65% by volume.

The first portion 2 and second portion 3 are in direct contact with each other and, hence, abut at an interface 15.

The first portion 2 is one-piece and is provided as a carbon-bonded first refractory material.

With regard to Table 1, two exemplary batches of refractory materials were fabricated to produce the first portion 2 comprising the following raw materials (all proportions in percent by mass, based on the respective total mass of the respective part):

TABLE 1

| | Example 1 | Example 2 |
|---|---|---|
| Tabular alumina > 0.045-2.0 mm | 48 | 53 |
| Tabular alumina > 0.0-0.045 mm | 24 | 25 |
| Zirconia corundum < 2.0 mm | 14 | |
| Secondary raw material (alumina based) | | 9 |
| Antioxidants | 6 | 6 |
| Carbon carriers | 4 | 3 |
| Binder | 4 | 4 |

As shown in Table 1, a mixture of alumina refractories with zirconia corundum refractories was used in Example 1.

In Example 2, a mixture of alumina refractories with secondary raw materials (based on alumina) was used.

The carbon carriers mentioned in Table 1 comprised graphite. The antioxidants mentioned in Table 1 comprised Si and/or Al. Both batches according to Examples 1 and 2 were further mixed with a resin binder.

In each case, the batches were mixed and pressed. Further, the batch according to Example 1 was fired under reducing conditions so that a carbon bond was formed, whereas the batch according to Example 2 was only tempered. After firing and tempering, respectively, the parts produced from the batches according to Examples 1 and 2 had the following proportions of oxides and carbon (all proportions in percent by mass, based on the respective total mass of the respective part), see Table 2 below:

TABLE 2

| | Example 1 | Example 2 |
|---|---|---|
| Al₂O₃ | 81.4 | 88.5 |
| SiO₂ | 8.7 | 4.0 |
| ZrO₂ | 3.5 | 2.0 |
| C | 6.0 | 5.1 |
| Remainder | 0.4 | 0.4 |

The second portion 3 is monolithic and made from a castable second refractory material. Two exemplary batches (Example 3 and 4) of such second refractory material were fabricated to produce the second portion 3, wherein raw materials in the form of alumina and bauxite were used (see Table 3). The batch further comprised additives and/or a dispersing agent and a binder (alumina refractory cement), as shown in Table 3 (all proportions in percent by mass, based on the respective total mass of the respective part):

TABLE 3

| | Example 3 | Example 4 |
|---|---|---|
| Tabular alumina > 0.0-3.0 mm | 58 | |
| Tabular alumina > 0.0-0.045 mm | 34 | |
| Bauxite < 0.0-3.0 mm | | 71 |
| Bauxite < 0.0-0.045 mm | | 23 |
| Additives/Dispersing Agent | 1.5 | 1 |
| Binder (alumina refractory cement) | 6.5 | 5 |

The castable was produced by adding water to the batches of Example 3 and 4. The oxide composition of the two embodiments of the castables, according to Examples 3 and 4, is shown in Table 4 below (all proportions in percent by mass, based on the respective total mass of the respective part):

TABLE 4

| | Example 3 | Example 4 |
|---|---|---|
| Al₂O₃ | 97.8 | 85.0 |
| SiO₂ | 0.1 | 10.0 |
| TiO₂ | | 2.5 |
| Fe₂O₃ | 0.1 | 1.1 |
| Remainder | 2.0 | 1.4 |

The above proportions of carbon and oxides in the first and second refractory materials according to Tables 2 and 4 are determined according to the standard by a combination of the standards ISO 12677 and ISO 21068-2 as set forth above.

According to one embodiment, the plate 1 was manufactured by first providing a metal frame 6 and then fixing the metal frame 6 and the first portion 2 relative to each other by means of a mold such that the first portion 2 was positioned within metal frame 6. The first portion 2 was one of the two parts according to the above Examples 1 or 2.

Subsequently, one of the two castables according to the above Examples 3 or 4 was cast into the frame 6 in the space between the first portion 2 and the frame 6. To cure the casting compound, the plate 1 was dried at 250° C. Subsequently, an exemplary embodiment of the refractory plate according to the invention was obtained.

In order to be able to determine the resistance of the plate according to the invention to ratholing, simulation tests were carried out. The occurrence of cracks in the area of the channel and their continuation in the plate caused by stresses in the area of the passage were simulated.

In FIG. 4, the results of such a simulation are shown. It can be clearly seen how cracks develop in the first portion 3, which extend from the area of the channel 4 to the edge of the first portion 2. At the interface 15 between the first portion 2 and the second portion 3, however, these cracks end so that they do not continue into the second portion 3.

For comparison purposes, corresponding simulation tests were carried out on a prior art slide plate. The results are shown in FIG. 5. The prior art plate 100 was made of a single refractory material 101. It is easy to see how cracks run throughout the refractory material 101 from the area of the channel 102 to the outer edge of the plate 100. In the practical application of such a plate 100, these cracks will result in increased ratholing.

1. A refractory plate (1) for use in a slide gate valve for controlling a flow of molten metal, comprising the following features:
1.1 a channel (4) passing through said plate (1) through which molten metal can flow;
1.2 a first portion (2) made of a first refractory material; wherein
1.3 said channel (4) is at least partially passing through said first portion (2); and
1.4 a second portion (3) made of a second refractory material; wherein
1.5 said channel (4) is spaced from said second portion (3); and wherein
1.6 said first refractory material is bonded by a carbon bond or a coking binder; and wherein
1.7 said second refractory material is not bonded by a carbon bond or a coking binder; and wherein
1.8 said second refractory material is comprised of 35 to 99% by mass Al₂O₃, of below 2% by mass carbon and of 1 to 65% by mass at least one of the following: SiO₂, CaO and Fe₂O₃; and wherein
1.9 said first portion (2) and said second portion (3) abut at an interface (15).

2. The refractory plate (1) according to claim 1, wherein said channel (4) is fully passing through said first portion (2).

3. The refractory plate (1) according to claim 1, wherein said first portion (2) is made by pressing.

4. The refractory plate (1) according to claim 1, wherein said first portion (2) is one-piece.

5. The refractory plate (1) according to claim 1, wherein said second portion (3) is monolithic.

6. The refractory plate (1) according to claim 1, wherein said first portion (2) and said second portion (3) are arranged in a frame (6).

7. The refractory plate (1) according to claim 6, wherein said first portion (2) is arranged with a distance from a radial outer rim portion (8) of said frame (6).

8. The refractory (1) plate according to claim 7, wherein said second portion (3) bridges said distance between said first portion (2) and said radial outer rim portion (8) of said frame (6).

9. The refractory plate (1) according to claim 1, wherein said first refractory material is comprised of 2 to 20% by mass carbon and of 80 to 98% by mass at least one oxide selected from the group consisting of: Al₂O₃, SiO₂, ZrO₂ and MgO.

10. A method for the production of the refractory plate (1) according to claim 1, comprising the following steps:
A. providing said first portion (2);
B. providing a batch from which said second portion (3) is castable;
C. casting said batch to form said second portion (3);
D. embedding said first portion (2) in said second portion (3).

11. Use of a refractory plate (1) according to claim 1 in a slide gate valve for controlling a flow of molten metal.

12. A slide gate valve for controlling a flow of molten metal, comprising the refractory plate (1) according to claim 1.

13. A vessel for containing molten metal comprising the following features:
13.1 an opening for discharging a flow of molten metal from said vessel; and
13.2 a slide gate valve according to claim 12; wherein
13.3 said flow of molten metal through said opening is controllable by said slide gate valve.
